(19) United States
(12) Patent Application Publication
(10) Pub. No.: US 2022/0051098 A1
(43) Pub. Date: Feb. 17, 2022

(54) VOICE ACTIVATED, MACHINE LEARNING SYSTEM FOR ITERATIVE AND CONTEMPORANEOUS RECIPE PREPARATION AND RECORDATION

(71) Applicant: Myka LLC, Summerville, SC (US)

(72) Inventors: Brent McCarthy, Summerville, SC (US); Natalie Tannous, Summerville, SC (US); Rahul Varshneya, Cary, NC (US)

(73) Assignee: Myka LLC, Summerville, SC (US)

(21) Appl. No.: 17/401,624

(22) Filed: Aug. 13, 2021

Related U.S. Application Data
(60) Provisional application No. 63/066,396, filed on Aug. 17, 2020.

(51) Int. Cl. G06N 3/08

(52) U.S. Cl. CPC G06N 3/08

(57) ABSTRACT

A system and process are provided for assisting a user to formulate and document a recipe as the user creates the recipe and cooks in real time. The user may speak to the system to describe or dictate appearances, quantities, ingredients, cooking time, and other factors and conditions, and the system interpolates, extrapolates, interacts, and makes suggestions to the user to complete and record the recipe without interfering with or halting the culinary process. As the system works with the user, the system grows in intelligence through an iterative learning process to become an AI sous chef.

### CROSS-REFERENCE TO RELATED APPLICATIONS

This utility patent application claims benefit of U.S. Provisional Patent Application Ser. No. 63/066,396, filed in the United States Patent and Trademark Office (“USPTO”) on Aug. 17, 2020, which is incorporated herein by reference thereto.

### BACKGROUND OF THE DISCLOSURE

When chefs, bakers, and other culinarians want to remember recipes as they are in the midst of creating a new dish, they cannot take notes without stopping to wash their hands to record their ideas since documenting a recipe on paper or via a digital device is nearly impossible without clean, dry hands. At the very least, touching papers or electronic devices with hands that are wet or soiled with food residue can damage the paper and electronics. Moreover, even a moment away from the act of cooking to record an idea may result in spoiling part of the recipe if various ingredients are being simultaneously sautéed, blended, and the like on different burners, in blenders, et cetera. and time is of the essence.

If chefs and bakers wait to document a recipe after a dish has been prepared and cooked, not only will recording the recipe afterwards consume additional time, but the chances also increase that one or more steps taken by the user while formulating the recipe and cooking the dish will be forgotten or overlooked. For instance, a busy chef might not remember all of the ingredients that were used, or forget their precise quantity, order, and other cooking nuances. Still further, makeshift documentation of recipe details during or after meal preparation leads to unorganized recipe data and inconsistencies across recipes. Thus, searching for a specific recipe in the future will waste more time due to the lack of a standard recording process. And the chances that the recipe was misremembered or recorded incorrectly may result in a disappointing dish when the recipe is reused. Eventually, some users can be dissuaded from documenting recipes due to the additional time and effort it takes to record them during or after the fact coupled with the inability to replicate dishes successfully.

Still further, the culinarian may not have time to precisely measure ingredients and characterize other metrics while creating a new dish, and instead, the chef may be using euphemisms and colloquialisms such as a “pinch” or a “dash” or descriptors like “until the oil shimmers.” Without an intelligent assistant, recipes using such terms, phrases, and conditions may be misinterpreted by someone later attempting to replicate the dish.

What is needed in the culinary industry is a system for documenting a new recipe with precise and nuanced details as the recipe is being created and prepared.

### BRIEF SUMMARY OF THE DISCLOSURE

The present disclosure is directed in general to an artificial intelligence (AI) or machine-learning system that comprehends and learns from user commands and contemporaneously determines ingredients and extrapolates their quantities from the steps of the recipes and conditions as described by the user. As the system learns, it can assist the user in quantifying and characterizing recipes. Through iterative, intelligent learning, the system becomes increasingly smarter to assist the culinarian as a sous chef.

The intelligent “sous chef” system is integrated with application programming interfaces (APIs) for interacting with the application and to facilitate information transfer to and from the system as needed. The system includes training algorithms that enable a continuous learning process. The training algorithms continually develop and learn to enable smooth functioning of the system. For instance, to run an algorithm to recognize the ingredients and measurements spoken by a user, an initial dataset can be provided with an interface. The interface permits future additions to the dataset to improve the algorithm and its results.

The order of the ingredients and their measurements and other nuances can be introduced into the system via voice input (primary) or text input (secondary). The user can add or edit the steps and/or ingredients and add pictures of a finished dish to help refine and complete the recipe for future reference. The system is easy to use and reliable and can be adapted to a variety of applications that call for interpolating, extrapolating, defining, understanding, interpreting, and recording steps, conditions, and ingredients or components necessary to finalize a recipe, procedure, and the like.

In one embodiment according to the disclosure, an iterative machine learning system is provided that intelligently sorts and articulates ingredients, quantities, steps, and conditions based on verbal descriptions from a user and interactively records a resulting recipe. The system may learn from the recipe and make suggestions to the user in future recipes. The system interactively engages with the user to learn what the user intends or means by new terms and observations, which are not in the system library.

The machine-learning system in this embodiment may, after learning and recording ingredients, quantities, steps, and conditions as the recipe in a library, use the learned knowledge to make suggestions to the user in the next recipe.

In another embodiment, a method of training a neural network for recipe discernment and compilation may comprise: collecting a set of information from the group consisting of temperatures, times, conditions, ingredients, quantities, visual appearance, and order of use; transforming one or more of the set of information to recipe steps; creating a library from the set of information; and training the neural network to intelligently assist in a subsequent recipe.

In a further embodiment, an artificial intelligent system may include a neural network trained to identify ingredients from steps stated by a user, display the steps to the user when prompted, interact with user to suggest ingredients, quantities, time, and order of use, and save the steps and ingredients and conditions in a library. New conditions, steps, and ingredients can be added to the library when a new recipe is being created using the previously saved steps, ingredients, and conditions in the library.

In another aspect of the disclosure, a method of iteratively creating and recording a recipe using a machine learning system may include: processing, by a chat system, an initial version of an artificial intelligence assistant based on a prepopulated library and a user input; generating, by the chat system, a response by the artificial intelligence assistant; generating user feedback to accept or modify the response from the artificial intelligence assistant; and recording or modifying by the chat system the response, the library or both, wherein the artificial intelligence assistant learns from the user feedback and the initial version is modified to a subsequent, smarter version. The prepopulated library may include a first set of commands, a first set of ingredients, and a first set of units of measure. Similarly, the user input may include a name, location, user preferences and the like. The user can communicate with the artificial intelligence assistant by verbal or typed commands.

The chat system—in the subsequent, smarter version based on the user feedback and expanded library—is able to suggest ingredients, steps, temperatures, and cooking times to the user in subsequent recipes. For instance, in a first iteration, a chef may state, “Add oil until it shimmers.” Oil is the ingredient, “add” is the step, and “until it shimmers” is the condition that reveals the amount. Initially, the system may need to query the chef, “What do you mean by shimmer?” or “How much oil did you use and at what temperature and for how long?” The next time the chef tells the system “until it shimmers,” the system will know the context and meaning. Furthermore, the system can recognize other recipes that may benefit from “adding oil until it shimmers” and begin making appropriate suggestions in other preparations. Moreover, once the system interprets the difference between warming and boiling, for example, it will iteratively understand that shimmering comes between these conditions, if applicable to a subsequent recipe.

In a further embodiment, a machine learning cooking assistant may include a processor, a tangible, non-transitory memory configured to communicate with the processor, the tangible, non-transitory memory having commands stored thereon that, in response to execution by the processor, causes the processor to perform operations comprising: processing, by the processor, a user chat input; selecting, by the processor, a current version of a recipe library based on the processed user chat input; generating, by the processor, an AI chat response based on the processed user chat input and a current version of the support chat profile; generating, by the processor, an AI query; receiving user chat feedback; and modifying, by the processor, the current version of the recipe library to a superior version of the recipe library.

The machine learning cooking assistant in this embodiment may include having the processor mimic an assistant that is learning based on a transformation from the current version of the recipe library to the superior version of the recipe library. Specifically, the processor, through iterative learning, can make suggestions to the user via the AI chat.

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode thereof directed to one of ordinary skill in the art, is set forth in the specification, which refers to the appended figures, wherein:

FIG. 1 is a schematic view of an embodiment of an artificial intelligence system according to the disclosure in which a user documents a recipe as it is being created while the system learns and interacts with the user to assist in creating and recording the recipe;

FIG. 2 is a schematic view of a system architecture as employed in the embodiment shown in FIG. 1;

FIG. 3 are charts showing an exemplary data base architecture as used in the system architecture of FIG. 2;

FIG. 4 shows an administrative panel for adding units in the data base architecture of FIG. 3 to assist in training the system;

FIG. 5 shows an administrative panel for adding or identifying ingredients in the data base architecture of FIG. 3 to further train the system;

FIG. 6 shows an administrative panel for adding or editing commands in the data base architecture of FIG. 3 to train the system;

FIG. 7A is a plan view of a smart phone showing an exemplary frontend or mobile application having three tiers;

FIG. 7B is a screenshot of a first tier Inside App Library as in FIG. 7A, particularly showing the artificial intelligence system or chatbot having a chat conversation with the user;

FIG. 7C is a snippet of code used to enable the chatbot in FIG. 7B;

FIG. 8A is a screenshot of a user interface displaying a swiftwave inviting the user to speak;

FIG. 8B is a snippet of code as used to enable the embodiment of FIG. 8A;

FIG. 9A is a screenshot of a user interface in which the user can initiate creation or recording of a recipe;

FIG. 9B is a snippet of code as used to enable the embodiment of FIG. 9A;

FIG. 10A is a screenshot of a user interface showing screen content and a touch keyboard being used in real time;

FIG. 10B is a snippet of code as used to enable the embodiment of FIG. 10A;

FIG. 11A is a screenshot of a user interface showing a menu;

FIG. 11B is a snippet of code as used to enable the embodiment of FIG. 11A;

FIG. 12A is a screenshot of a user interface showing a terms of service being accessed;

FIG. 12B is a snippet of code as used to enable the embodiment of FIG. 12A;

FIG. 13 is a code snippet showing speech framework to recognize spoken words in recorded or live audio used in various embodiments of the disclosure;

FIG. 14 are exemplary screenshots of a user interface upon initial launch of the embodiment as in FIG. 1;

FIG. 15 are exemplary screenshots of a user interface during cooking as used with the embodiment of FIG. 1;

FIG. 16 are exemplary screenshots showing interaction between the system of FIG. 1 and the user during recipe creation; and

FIG. 17 is an exemplary screenshot of a user interface showing a recipe preview or storage options as in the system of FIG. 1.

### DETAILED DESCRIPTION OF THE DISCLOSURE

As required, detailed embodiments are disclosed herein; however, the disclosed embodiments are merely examples and may be embodied in various forms. Therefore, specific structural and functional details disclosed herein are not to be interpreted as limiting, but merely as a basis for the claims and as a representative basis for teaching one skilled in the art to variously employ the exemplary embodiments of the present disclosure, as well as their equivalents.

Unless defined otherwise, all technical and scientific terms used herein have the same meaning as is commonly understood by one of ordinary skill in the art to which this disclosure belongs. In the event that there is a plurality of definitions for a term or acronym herein, those in this section prevail unless stated otherwise.

The phrase “Artificial Intelligence” (AI) means a synthetic entity that can make decisions, solve problems, and function like a human being by learning from examples and experience, understanding human language, and/or interactions with a human user, i.e., via a chat system. The AI synthetic entity may be equipped with memory and a processor having a neural network, as well as other components, that can iteratively learn via supervised machine learning (ML) (for example, through inputted data) or capable of autonomous, unsupervised deep learning (DL) (for example, based on inputted data or perceived data and trial and error). AI, ML, and DL may be used interchangeably herein.

A neural network as used herein means AI having an input level or data entry layer, a processing level (which includes at least one algorithm to receive and interpret data but generally at least two algorithms that process data by assigning significances, biases, et cetera to the data and interact with each other to refine conclusion or results), and an output layer or results level that produces conclusions or results.

Wherever the phrase “for example,” “such as,” “including,” and the like are used herein, the phrase “and without limitation” is understood to follow unless explicitly stated otherwise. Similarly, “an example,” “exemplary,” and the like are understood to be non-limiting.

The term “substantially” allows for deviations from the descriptor that do not negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, et cetera. Thus, for example, “a device having components a, b, and c” means that the device includes at least components a, b, and c. Similarly, the phrase: “a method involving steps a, b, and c” means that the method includes at least steps a, b, and c.

Where a list of alternative component terms is used, e.g., “a structure such as ‘a’, ‘c’, ‘d’ or the like,” or “a” or b,” such lists and alternative terms provide meaning and context for the sake of illustration, unless indicated otherwise. Also, relative terms such as “first,” “second,” “third,” “front,” and “rear” are intended to identify or distinguish one component or feature from another similar component or feature, unless indicated otherwise herein.

Unless the context clearly requires otherwise, throughout the description and the claims, the words “comprise,” “comprising,” and the like are to be construed in an inclusive sense as opposed to an exclusive or exhaustive sense; in the sense of “including, but not limited to.”

The various embodiments of the disclosure and/or equivalents falling within the scope of present disclosure overcome or ameliorate at least one of the disadvantages of the prior art or provide a useful alternative.

Detailed reference will now be made to the drawings in which examples embodying the present subject matter are shown. The detailed description uses numerical and letter designations to refer to features of the drawings. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. The drawings are not necessarily to scale, and some features may be exaggerated to show details of particular components. Thus, the examples set forth in the drawings and detailed descriptions are provided by way of explanation only and are not meant as limitations of the disclosure. The present subject matter thus includes any modifications and variations of the following examples as come within the scope of the appended claims and their equivalents.

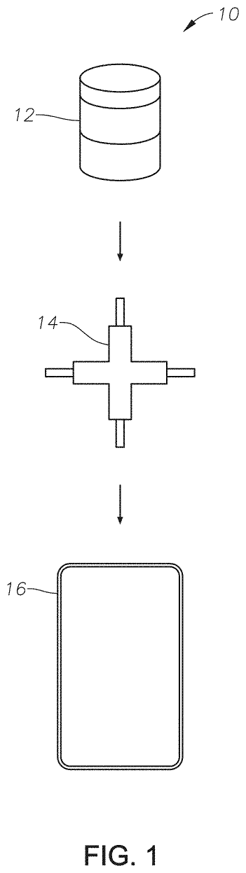

Turning now to FIG. 1, an overall architecture of an exemplary machine-learning or artificial intelligence (AI) system or application is designated in general by the element number 10 and includes a voice assistant named MYKA®, which is described in greater detail below. The exemplary MYKA® system 10 may include a database (DB) and a database management system (DBMS) or processor 12, a backend or bridge 14, and an application screen 16, also known as a frontend or user interface (UI). The DBMS 12 includes a collection of structured information or data that can be stored electronically in a computer system and controlled by the DBMS 12 (i.e., a neural network). In this example, the DBMS 12 for the MYKA® system 10 may be MongoDB, Version 4.2.8, which is an asynchronous language that quickly retrieves data from a DB. Here, MongoDB has a tangible, non-transitory memory used to store ingredients, units, commands, phrases, and other related information in JSON (JavaScript Object Notation) format.

The bridge 14 schematically shown in FIG. 1 is an interactive, real-time, iterative link or bridge between the UI 16 and the database and algorithm logic in the DBMS 12. In this example, the bridge 14 uses Node.js with Express Application version 14.0.0, which includes logic and connections. Node.js is used for I/O bound, Data Streaming, Data Intensive Real-time (DIRT), and JSON APIs.

The UI 16 shown in FIG. 1 may utilize Angular 9 (cli version 9.0.5). Angular 9 provides IDE (Integrated Development Environment) and a language service extension to develop the MYKA® application.

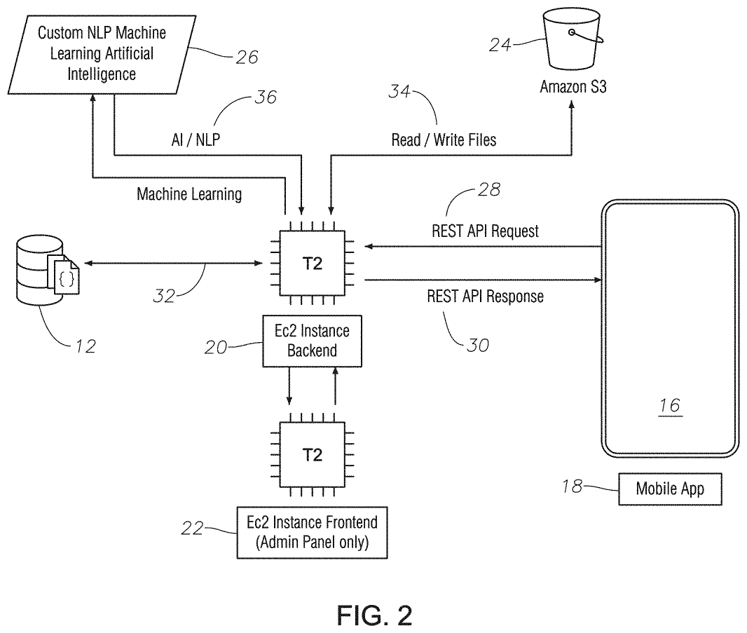

FIG. 2 shows the system architecture of the MYKA® application 10. Here, although other suitable components and software may be used, the exemplary system architecture may employ these components and software modules:

Mobile Application 18 installed on the UI 16

Ec2 Instance-Backend 20

Ec2 Instance-Fronted (Admin Panel only) 22

MongoDB Database 12

Amazon S3 bucket 24

AI/NLP (Custom NLP Machine Learning Artificial Intelligence) 26

For the Mobile Application 18, a flow and iterative, real-time learning process begins when a user initiates some action in the MYKA® application 10 via the UI 16. Such actions may include:
a. Initiating manual input by typing or tapping on a screen or any button or key of the UI 16.
b. Speaking to utilize a voice input of the UI 16 to create and record a recipe.
c. Speaking a command to the MYKA® application 10 via the UI 16.
d. Typing a manual command to the MYKA® application 10 via a button or key of the UI 16.
e. Uploading files (e.g., images, profile pictures) to the MYKA® application 10 via the UI 16.

As shown in FIG. 2 when the foregoing and other actions are performed, REST (REpresentational State Transfer) API (application programming interface) requests 28 are sent to the Ec2 Instance-Backend server 20. The REST API requests 28 are a software architectural style that defines a set of constraints to be used for creating Web services while an API is a set of rules that allow programs to communicate with each other. Here, the API has been developed on the server 20 to permit the user to transfer data. The REST aspect determines how the API will look, and one of the REST rules permits the user to retrieve a piece of data (also called a resource) when the user links to a specific URL. Each URL is termed a request 28 and the responsive data returned to the user is termed a REST API Response 30.

The Ec2 Instance Backend 20 shown in FIG. 2 is a backend server for the MYKA® application 10. More specifically, the MYKA® application 10 is connected to the Ec2 Instance Backend server 20. Each request/response 28, 30 with the MYKA® application 10 will be operated through this backend server 20. The Ec2 Instance Backend 20 is connected with following components to send, receive, and manipulate data to output the response 30 to the UI 16:

The Ec2 Instance-Frontend server 22 in FIG. 2 is developed for the purpose of training the AI within the MYKA® application 10. The server or Administrator Panel 22 (“Admin panel”) is operated by the user to set a foundational knowledge of the AI on the basis of which the AI will respond and learn through an iterative process. As described in further detail below, the connection between the backend server 20 and the frontend server 22 activates for the AI during recipe creation to identify ingredients and quantities or when valid commands are received for the MYKA® application 10.

As briefly introduced in FIG. 1, the MongoDB Database 12 also shown in FIG. 2 saves information in structured form, which can be retrieved for response purposes, schematically indicated by element number 32, by the Ec2 instance backend server 20. Information related to the user, recipes, ingredients, units, and commands are stored in the database 12.

The Amazon S3 bucket 24 in FIG. 2 saves all files uploaded by the user. The Ec2 Instance Backend server 20 has read/write access, schematically indicated by element number 34, to the Amazon S3 bucket 24. Here, the Ec2 Instance Backend server 20 accesses the saved files depending on the request 28 it receives from other peripherals.

AI/NLP processing 36 also is shown in FIG. 2, which makes it possible for humans to talk to machines. More specifically, NLP (Natural Language Processing) is a branch of Machine Learning/AI that enables computers to understand, interpret and manipulate human language. Here, it is used whenever user is creating or accessing the recipes through the MYKA® application 10.

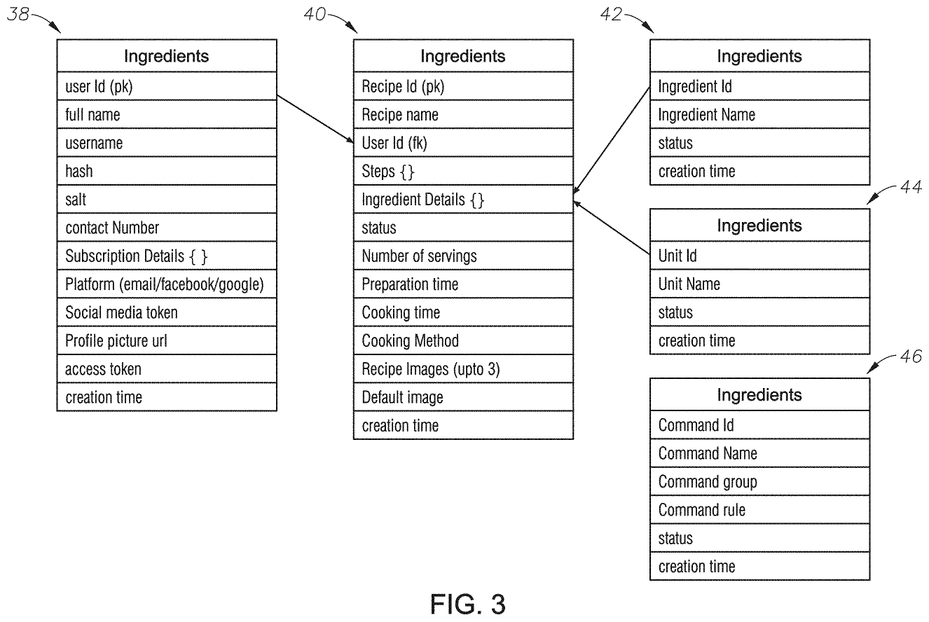

With reference now to FIG. 3, a database architecture includes various tables:

1. Users 38 (End Users who will use the application)

2. Recipes 40 (Created by users or pre-installed in the application)

3. Ingredients 42 (Respective to a recipe in which the Recipe table 38 is the parent table)

4. Units 44 (Respective to a recipe in which the Recipe table 40 is the parent table)

5. Commands 46 (verbal instructions by the user for the MYKA®AI to perform an action)

The MYKA® application 10 uses the various tables of the database architecture shown in FIG. 3 in the following manner. The User table 38 include various attributes for a user such as:
a. User ID. This is the primary key upon which the table is built. It will be created in the backend when an end user registers an account with the application.
b. Full name
c. Username
d. Hash
e. Salt
f. Subscription details{ ]
g. Platform (e.g., email, Facebook®, Google®)
h. Social media token
i. Profile picture URL
j. Access token
k. Creation time

The Recipes table 40 in FIG. 3 may include these attributes:
a. Recipe ID (primary key)
b. Recipe name
c. User ID (foreign key, as user ID is taken from another Table, as recipe is created by some user, user id is linked to a respective recipe)
d. Steps{ }
e. Ingredients details{ }
f. Number of servings
g. Preparation time (e.g., in minutes)
h. Cooking time (e.g., in minutes)
i. Cooking method
j. Recipe images (e.g., up to 3)
k. Default image
l. Creation time

As further shown in FIG. 3, the Ingredients table 42 is a child table of the Recipe table 40. Ingredients trained from the Admin Panel 22 are saved in table 42. Attributes for ingredients may include:

a. Ingredient ID

b. Ingredient name

c. Status

d. Creation time

The Units table 44 also is a child table of the Recipe table 40. Units trained from the Admin panel 22 are saved in the Units table 44, and its attributes may include:

a. Unit ID

b. Unit name

c. Status

d. Creation time

The Commands table 46 are trained from the Admin Panel 22 and saved here.

Attributes stored for commands may include:

a. Command ID

b. Command name

c. Command group

d. Command rule

e. Status

f. Creation Time

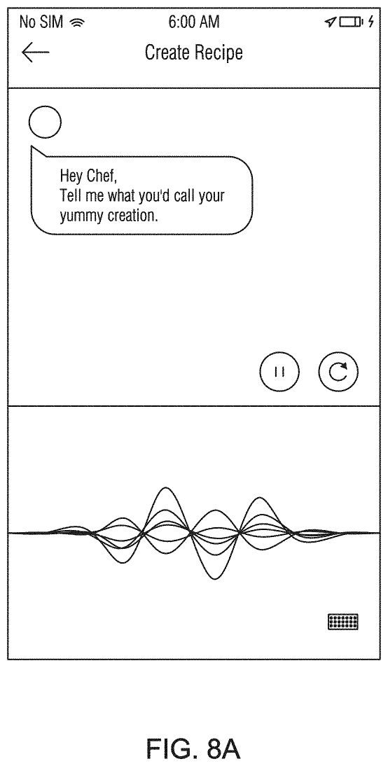

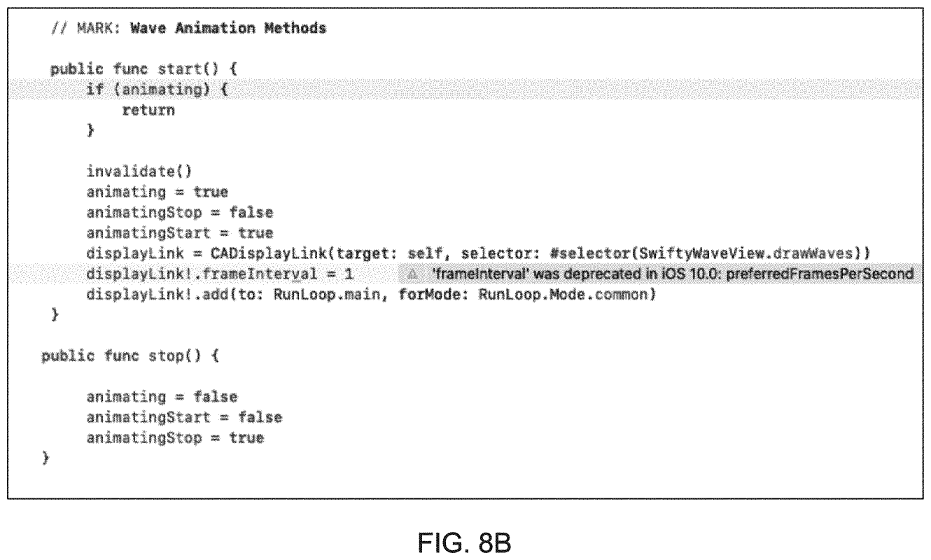

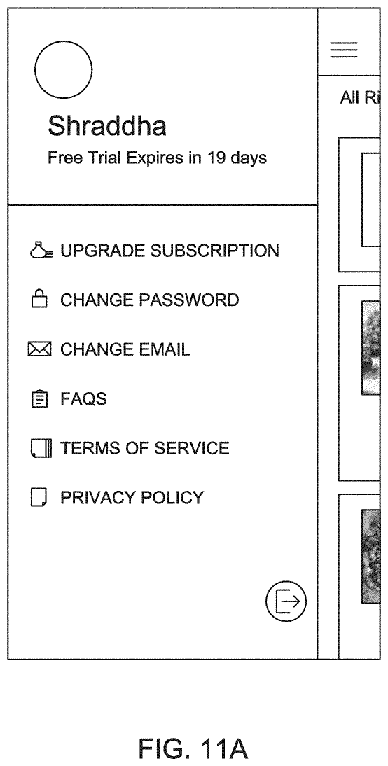

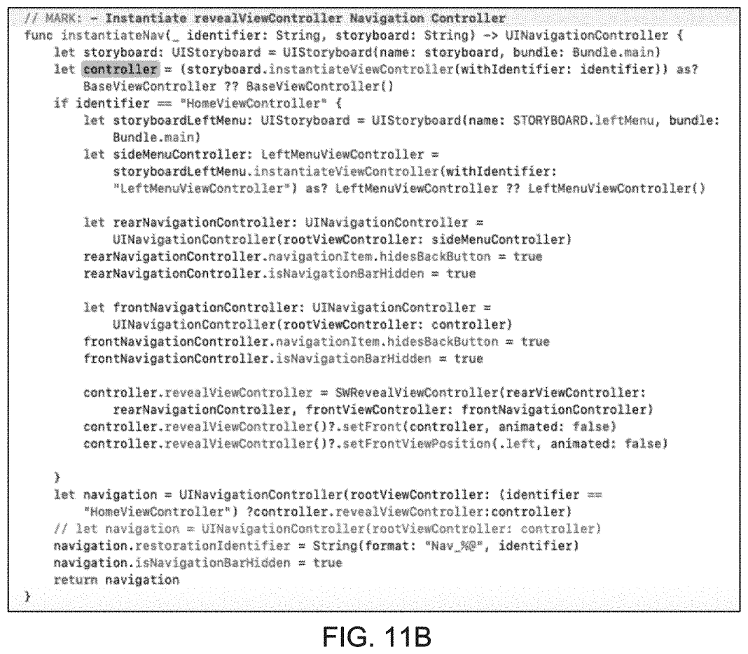

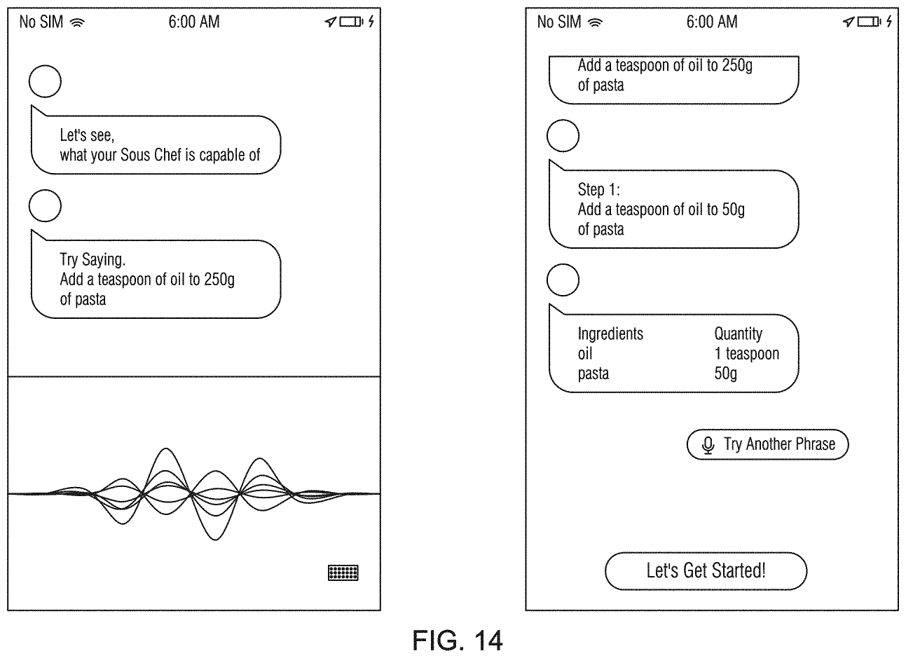

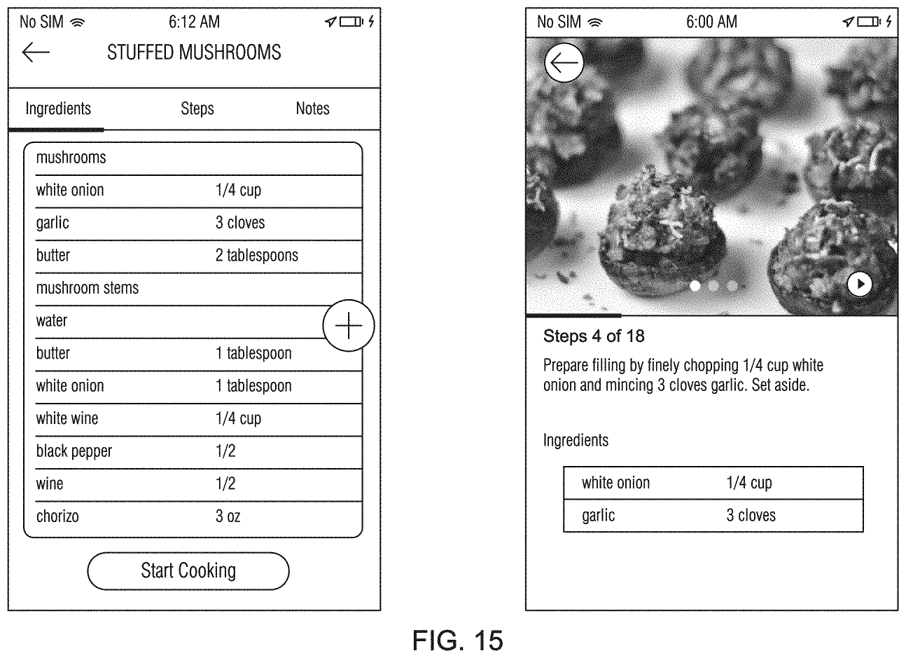

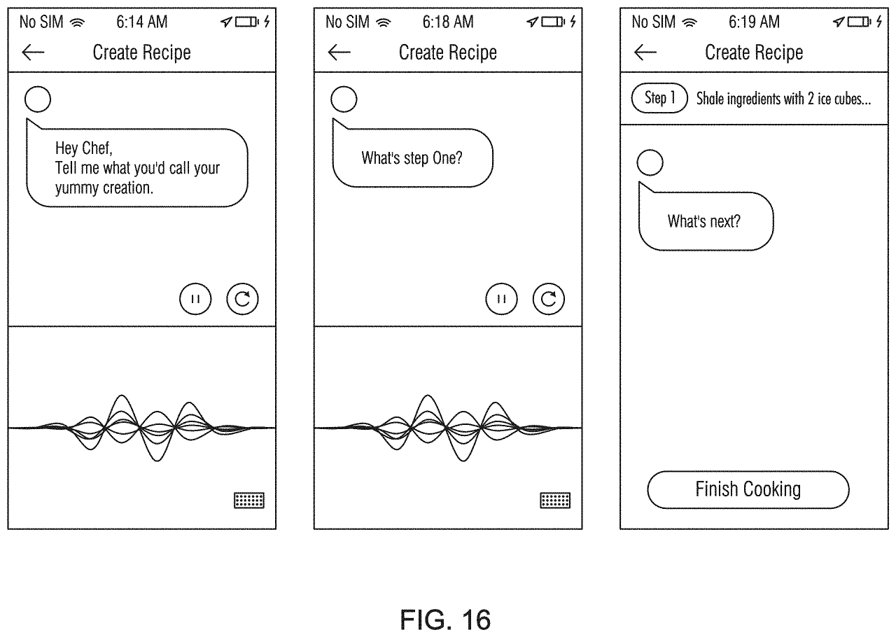

By way of exemplary operation, the data in the foregoing tables of FIG. 3 are used and stored in the following flow or manner. Once a user has signed up on the MYKA® application 10 with required credentials, the user can set a profile by entering their personal username and uploading a profile picture if desired. The user can check subscription details and upgrade a subscription plan as and when needed (see FIG. 11). A user can then create a recipe in following steps via their UI 16 (see FIGS. 1 and 2):
a) A User enters a Recipe Title (see, e.g., FIGS. 8, 10, and 16).
b) The User dictates steps to the MYKA® app, which the MYKA® AI detects & displays (see FIGS. 14 and 16).
c) From the dictated steps, MYKA® detects and displays ingredients and quantities (see FIGS. 14 and 15).
d) The User has an option to edit the steps or change the steps sequence.
e) The Recipe is saved in a database which can be accessed by the user (see FIG. 15).

Thus, the user can access Start Cooking for any recipe (saved/pre-installed), or users can give commands to the MYKA® app to navigate from one screen to another and perform set particular steps.

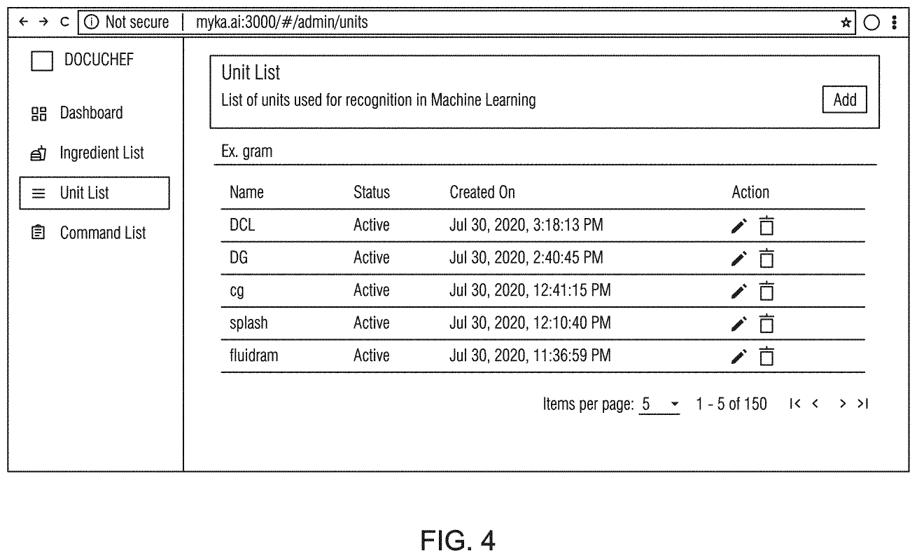

Turning now to FIG. 4, a human-interface, user-friendly Admin Panel (depicted as the Frontend server 22 in FIG. 2) is shown. The MYKA® AI is trained through the Admin Panel by the owner or user; i.e., the user is the Administrator for MYKA® application 10. The user can continuously train the AI to enable an iterative learning process for the MYKA® application 10. On the basis of embedded training AI algorithms, the MYKA® application 10 continues to develop. For instance, the MYKA® application 10 may query and learn from the user that a “pinch” means approximately 1/16^{th} of a teaspoon. Thus, in a new recipe when the user again says “pinch” the MYKA® application 10 will remember what it means and record it, accordingly, perhaps displaying it like so: “Add a pinch of salt (− 1/16^{th} TSP).”

The Admin panel in FIG. 4 is used to train the MYKA® application 10 and may include various sections. As shown in this example, a menu is displayed on the left side of the screen which may include a Dashboard, an Ingredients list, a Units list, and a Command list. In the header to the far right, the user has the option to logout. If the Units list is selected as shown in FIG. 4, the AI is trained to identify ingredient's units from the steps given by the user (i.e., a first data set), display those to the user wherever required and save them. Units can be initially added from a Master Units List such as a “splash” or specific weights and measurements. And as introduced above, if the user uses a new unit of measurement or says a new term such as “pinch,” the MYKA® application 10 can ask the user to define the term, and it will be added to the library for future reference (i.e., a second data set).

By way of example operation, if the user clicks on the Units list in FIG. 4, a list of known units will appear on the screen and the following details of each unit will be displayed:

a. Name (entered by user from Add action)

b. Status (active by default; can be changed to inactive as desired)

c. Created on (displayed by default)

d. Actions (Edit and delete)
i. When the user clicks the ‘Edit’ icon, ‘Edit unit’ window will pop up which includes following fields & actions—
   Unit name (user will edit the name)
   Status (user will select the status)
   Save (By clicking the ‘Save’ button, the unit will be saved & updated in the list)
   Close (By clicking the ‘Close button’, the user be returned to the list without saving the unit)
ii. When the user clicks on the ‘Delete icon’, a ‘Confirm action’ window will pop up asking the user to be sure that the user wants to delete the unit.
   Delete (item will be deleted and removed from the list)
   Cancel (the user will be returned to the list without deleting the unit)

Upon clicking the ‘Add’ button at the top right of the screen in the example shown in FIG. 4, the user will be able to add a new unit to the list. When the user clicks the ‘Add’ button, an ‘Add unit’ window will pop up that includes following fields & actions:
a. Unit name (the user types the name)
b. Status (the user selects status)
c. Save (By clicking the ‘Save’ button, the unit will be saved and updated in the list)
d. Close (By clicking the ‘Close button’, the user will be returned to the list without saving the unit)

An additional aspect of the Admin Panel shown in FIG. 4 is a search feature. In the ‘Search’ placeholder, the user can type & search for an existing unit in the library. The MYKA® application 10, through an iterative learning process, may suggest units to the user. The user can also select the number of items to be displayed on a page. This can be selected at the bottom of the list to the right side in this example wherein the user can navigate between pages with the assistance of “next” and “previous” arrows.

The logical layer and database connection that enables the foregoing iterative operations regarding the AI's understanding of Units and their recording includes, in the Ec2 Instance Backend server 20, the exemplary code listed at Extraction 1 in the attached Appendix.

The exemplary code at Extraction 2 of the Appendix permits the Admin Panel to be displayed with units as shown in FIG. 4.

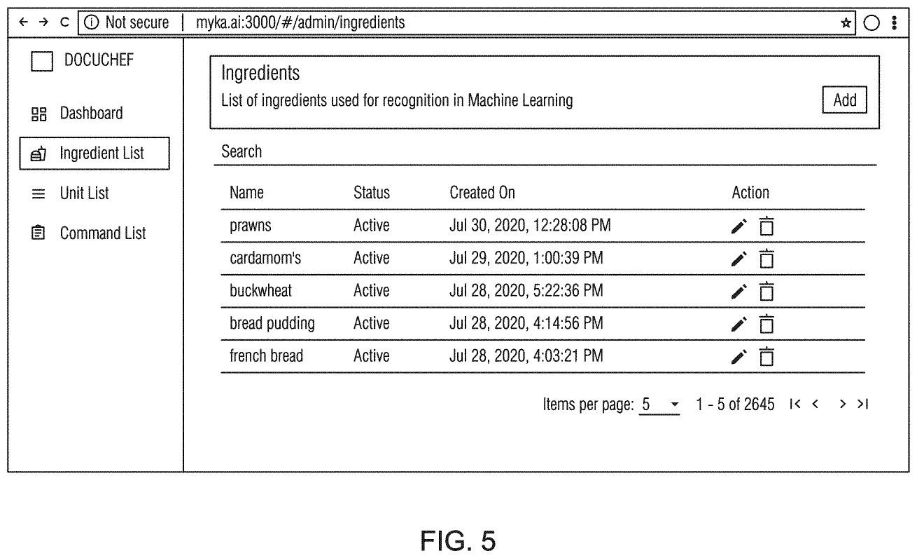

With reference now to FIG. 5, the Admin Panel is shown with the Ingredients list selected by the user. With this list selected, the AI is trained to identify ingredient from the steps stated by the user, display those to the user wherever required and save them. A process with which ingredients can be added may begin with an initial Master Ingredients list. Upon clicking the Ingredient list, previously recorded ingredients will appear on the screen which will display details of each ingredient such as:

a. Name (entered by user from Add action)

b. Status (Active by default; can be changed to inactive)

c. Created on (displayed by default)

d. Actions (Edit and delete)
i. When the user clicks the ‘Edit’ icon, an ‘Edit ingredient’ window will pop up which includes following fields & actions:
   Ingredient name (the user edits the name)
   Status (the user selects the status)
   Save (By clicking the ‘Save’ button, the ingredient will be saved and updated in the list)
   Close (By clicking the ‘Close button’, the user will be returned to the list without saving the ingredient)
ii. When the user clicks on the ‘Delete icon’, a ‘Confirm action’ window will pop up asking the user to be sure that the ingredient is to be deleted.
   Delete (the ingredient will be deleted and removed from the library)
   Cancel (the user will be returned to the list without deleting the ingredient)

Upon clicking the ‘Add’ button at the top of the screen in FIG. 5, the user will be able to add a new ingredient to the list. When the user clicks the ‘Add’ button, an ‘Add ingredient’ window will pop up which includes following fields & actions:
a. Ingredient name (the user needs to type the name)
b. Status (the user needs to select the status)
c. Save (By clicking ‘Save’ button, the ingredient will be saved & updated in the list)
d. Close (By clicking ‘Close button’, the user will be returned to the list without saving the ingredient)

In the ‘Search’ placeholder shown near the top left of the screen in FIG. 5, the user can type and search for ingredients already in the library. The user can also select a number of items to be displayed on one page by selecting that number at the bottom of the list to the right side of the screen in this example. The user also can navigate between pages with the help of next & previous arrows as shown.

The logical layer and database connection that enables the foregoing iterative operations regarding AI Ingredient understanding and recording includes the following exemplary lines of code in the Ec2 Instance Backend server 20 at Extraction 3 of the Appendix.

The exemplary code at Extraction 4 of the Appendix permits the Admin Panel to be displayed with ingredients as shown in FIG. 5.

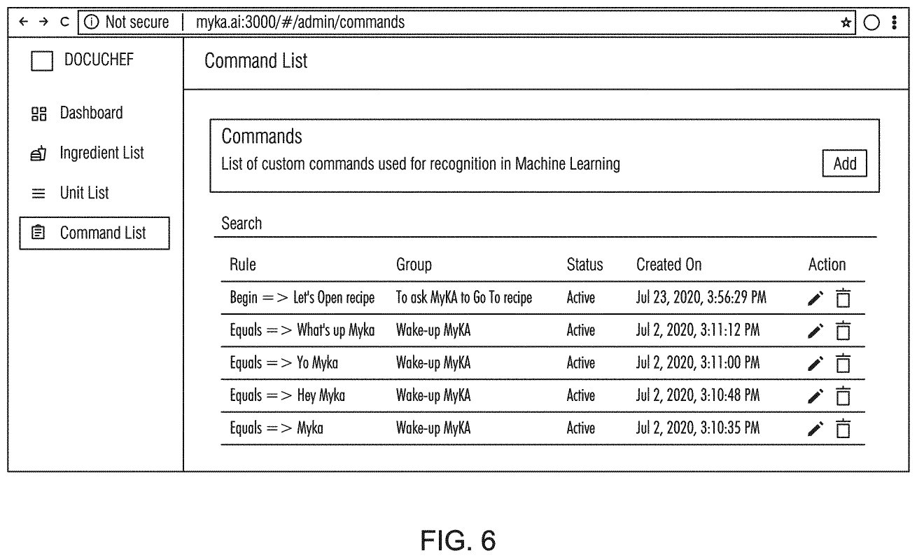

The Admin Panel is shown FIG. 6 with the Commands list selected by the user. With this list selected, all of the commands that the AI is supposed to understand and upon which the MYKA® application 10 should act will be trained to the system. Upon clicking the Command list, previously added commands will appear on the screen which will display details such as:

a. Rule (entered by the user from Add action)

b. Group (selected by the user from Add action)

c. Status (Active by default; can be changed to inactive as desired)

d. Created on (displayed by default)

e. Actions (Edit and delete)
i. When user clicks the ‘Edit’ icon, ‘Edit command’ window will pop up which includes following fields & actions:
   Rule (admin needs to select from rule operator)
   Rule text (admin needs to type the text which system is supposed to recognize with the help of the rule)
   Admin can add multiple Rules & rule text for respective Rule with the help of ‘Add’ button
   Command Group (Admin needs to select from predefined commands)
   Status (admin needs to select the status)
   Save (By clicking ‘Save’ button, Command will be saved & updated in the list)
   Close (By clicking ‘Close button’, admin will be returned to the list without saving the Command)
ii. When the admin clicks on the ‘Delete icon’, a ‘Confirm action’ window will pop up asking the admin if they are sure they want to delete the Command.
   Delete (it will delete the item & remove it from list)
   Cancel (admin will go taken back to the list without deleting the Command)

Upon clicking the ‘Add’ button at the top of the screen, the user will be able to add a new command to the list. When the user clicks the ‘Add’ button, an ‘Add command’ window will pop up which includes following fields & actions:
a. Rule (admin need to select from rule operator)
b. Rule text (admin needs to type the text which system is supposed to recognize with the help of the rule)
c. Admin can add multiple Rules & rule text for respective Rule with the help of ‘Add’ button in here
d. Command Group (Admin needs to select from predefined commands)
e. Status (admin need to select the status)
f. Save (By clicking ‘Save’ button, command will be saved & updated in the list)
g. Close (By clicking ‘Close button’, admin will go back to the list without saving the command)

In the ‘Search’ placeholder admin can type & search for an already added command. The user can also select the number of items to be displayed on one page. This can be selected at the bottom of the list to the right side of the screen in this example, and the user can navigate between pages with the help of next & previous arrows.

Because data trained and added in the MYKA® application 10 will be unique, training the AI to understand ingredients, units, and commands may include training the MYKA® application 10 to differentiate between singular and plural units; for example, kilogram and kilograms. Data ‘added’ in the Admin Panel will have to be ‘trained,’ manually initially, and then the MYKA® application 10 can begin to inquire or make suggestions about new data.

The logical layer & database connection that enables the foregoing iterative operations regarding AI's understanding of commands includes the exemplary lines of code in the Ec2 Instance Backend server 20 at Extraction 5 of the Appendix.

The exemplary code at Extraction 6 of the Appendix permits the Admin Panel to be displayed with commands as shown in FIG. 6.

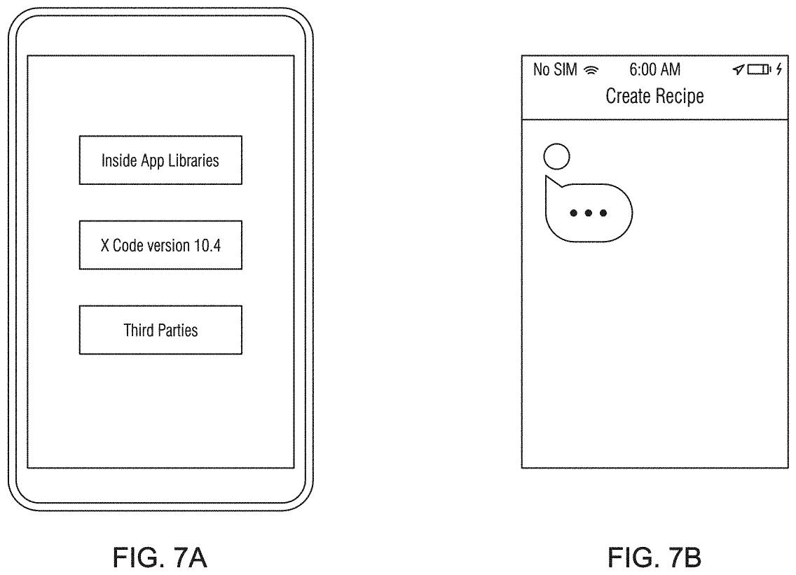

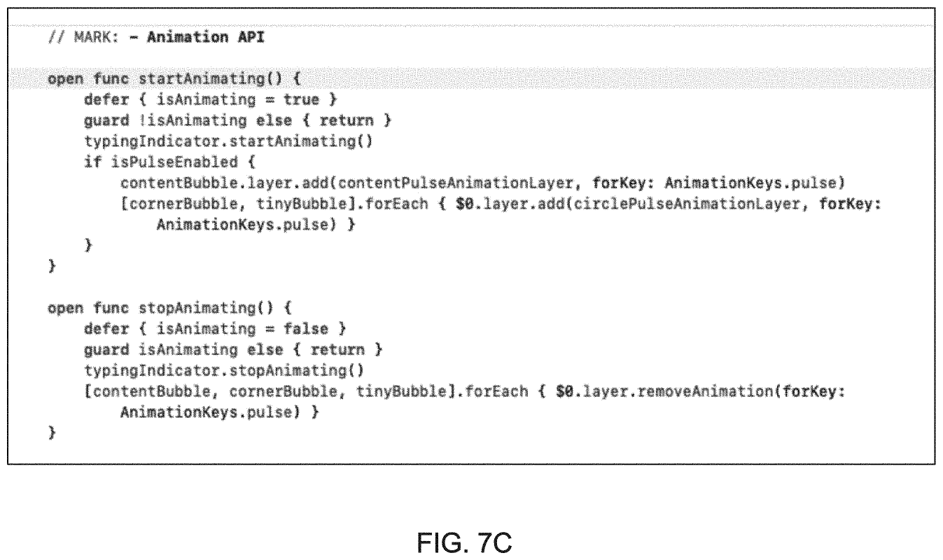

FIG. 7A shows a Frontend mobile architecture for training the MYKA® application 10, which runs on three tiers; i.e., a Tech Stack, and Inside App Library, and Third-Party Frameworks. The tech stack is a combination of software products and programming languages used to create the web or mobile application. Applications have two software components: client-side and server-side, also k s front-end and back-end. Here, a tech stack used for the frontend of the MYKA® application 10, although not limited to these examples, may include Xcode Version—10.4, iOS Support—11.0 and above, and an iPhone® smart phone.

The Inside App Library is shown in FIG. 7A with a corresponding typing bubble (e.g., replica of iMessage's typing indicator bubble) in FIG. 7B. This bubble is shown whenever the MYKA® application 10 is having a chat conversation with an end user. FIG. 7C shows exemplary code enabling the interactive view in FIG. 7B.

In FIG. 8A, SwiftWaves (Sound Wave) are displayed when the end user is given specific time to speak on certain screens. The waves are static animation and do not move on the basis of user's pitch or volume. FIG. 8B shows exemplary code enabling the interactive screen of FIG. 8A.

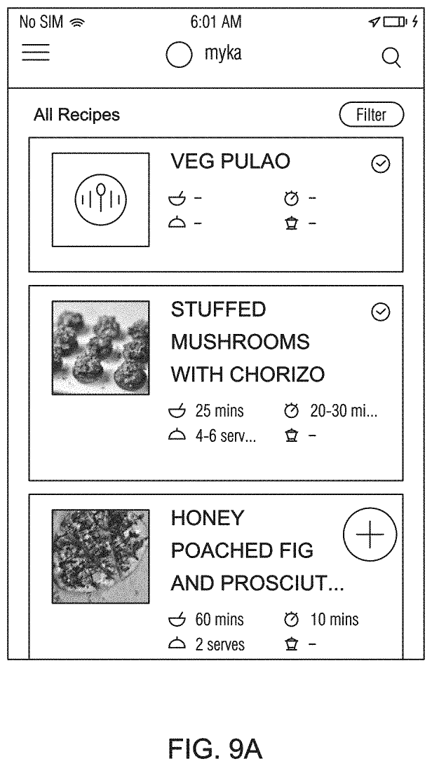

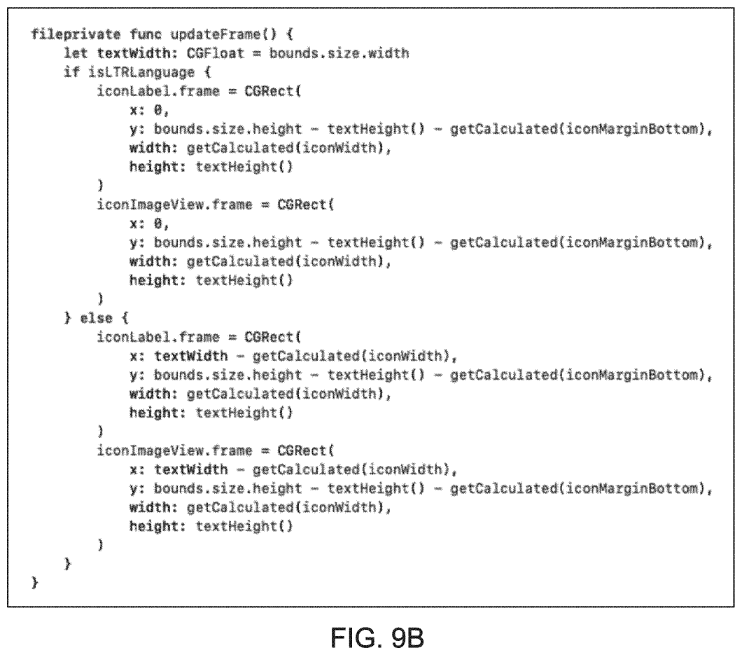

Turning to FIG. 9A, a “Sky floating text field screen is shown in which a user can initiate the process of creating and recording a recipe by tapping on the screen. FIG. 9B shows exemplary code that produces the screen in FIG. 9A.

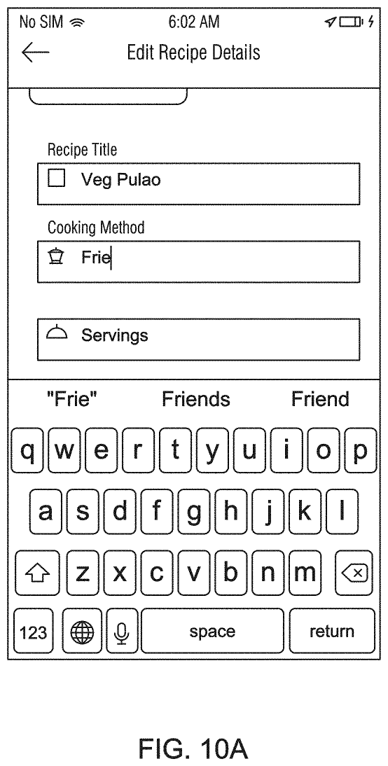

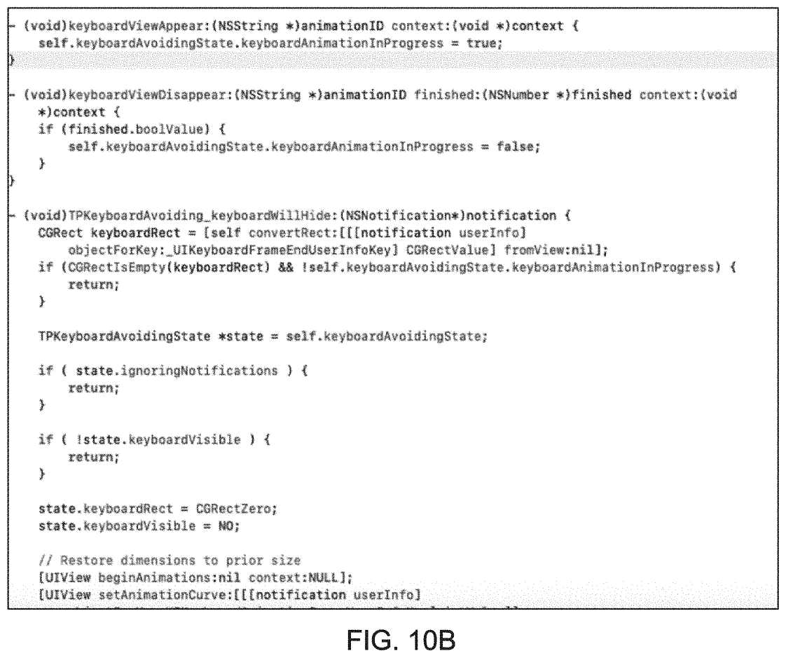

FIGS. 10A and 10B show a TPKeyboard aspect and its underlying code. Here, text fields may be moved out of the way of the keyboard. When configured, it will automatically adjust the position of the contents of the screen for a better fit when a user focuses on a field and the keyboard appears. The voice interactive app will receive the manual input wherever required to open the keyboard feature when tapped.

FIGS. 11A and 11B show SWRevealViewController and its underlying code for revealing a rear (left and/or right) view controller behind a front controller. Here, it appears as a side menu drawer in the app.

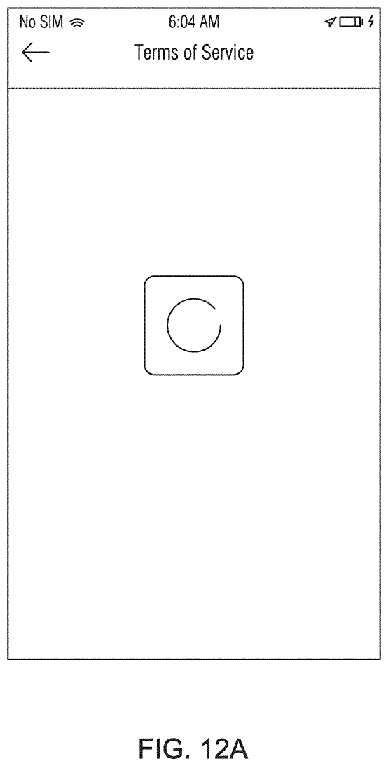

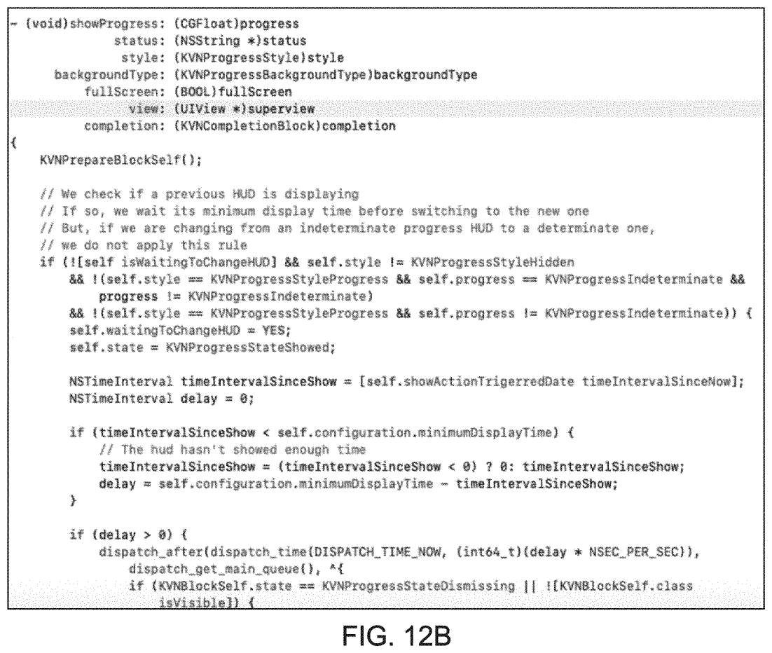

FIG. 12A shows KVNProgress, which is a customizable progress HUD (heads-up display) that can be full screen or not). This is the design displayed to the user while the data/screen of the application is getting loaded at the backend. The underlying code is shown in FIG. 12B.

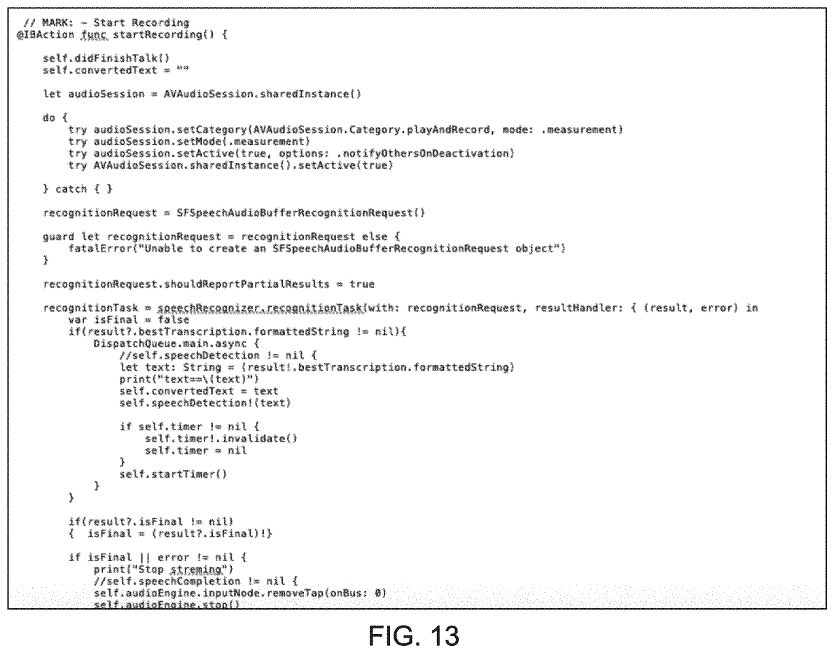

In FIG. 13, exemplary code for the AI's Speech framework is shown. The Speech framework is used to recognize spoken words in recorded or live audio. Its functionality includes an Internet connection to reach out to third party servers when different languages are used and for speech recognition on audio files and live recordings. The Speech framework also has a RecognitionTask.finish, which is called before checking information on the recognized speech. A timer is utilized to stop speech recognition after the user has stopped speaking.

A third-party framework as used in FIG. 13 may be written by some developers with iOS SDK to pre-pack some features in the AI. Suitable third-party frameworks that may be employed in the MYKA® application 10 include but are not limited to:
SDWebImage: This library provides an async image downloader with cache support, which may be used for when an end user wants to upload images for a recipe or for a profile picture.
Atributika may be used to build NSAttributedString. It is able to detect HTML for the MYKA® application such as regex or standard iOS data detectors and style them with various attributes like font, color, et cetera.
SVPinView is a customizable library used for accepting PIN numbers or one-time passwords MYKA® can use with the OTP method to verify email.
CropViewController may be used in the MYKA® App for functionalities such as editing profile pictures.
SKPhotoBrowser is a viewer that may be used to browse photos to upload for a recipe or for a profile picture.
MXParallaxHeader is a simple header class for UlScrollView. When a recipe detail screen is scrolled, the effect inculcated is the parallax header.
FacebookLogin, GoogleSignIn, etc.: the MYKA® App will permit users to sign up and login through third party social sites such as Facebook® and Google®.
Alamofire is a Swift-based HTTP networking library for iOS and macOS. It provides an interface on top of Apple's Foundation networking stack that simplifies a number of common networking tasks. Alamofire provides chainable request/response methods, JSON parameter and response serialization, authentication, and many other features like to perform basic networking tasks like uploading files and requesting data from a third-party RESTful API.
SpinKit is a simple loading spinner, animated third-party framework that provides a set of spinners or loaders. They are used if the MYKA® App faces a heavy load task or to help with a transition between scenes.
SwiftGifOrigin is a small UIImage extension with GIF support. The MYKA® App may use image objects to represent image data, and the UIImage class is capable of managing data for all image formats supported by the underlying platform. The v App may use it in these ways:
   Assign an image to a UIImageView object to display the image in Application interface.
   Use an image to customize system controls such as buttons, sliders, and segmented controls.
   Draw an image directly into a view or other graphics context.
   Pass an image to other APIs that might require image data.

The behavior and responses of the MYKA® App voice assistant or chatbot in various workflows of the application such as “General behavior” in which:
The system will play a sound when the MYKA® voice assistant is listening, so the user will know when to speak.
The system will play a sound when MYKA® voice assistant is finished listening, so the user will know that MYKA® has received the command and performed the action accordingly.
The system will pre-set the MYKA® voice assistant verbal response, in some scenarios, where MYKA® will perform a required action accordingly. When the MYKA® voice assistant gives a verbal response to the user's command, no sound will be played by the system to notify the user that MYKA® has finished listening.
The user can give verbal commands only by calling out the wake-up call to MYKA®, e.g., “Hey Myka” or “Hey Myka, please search Pina Colada recipe for me.”

Turning to FIG. 14, a walkthrough screen is shown which occurs when the user launches the MYKA® application 10 for first time after installation. Specifically, when the user launches the MYKA® App, the user is initially taken through the walkthrough screens, where the user can experience how the application is going to help create, record, and save a recipe. Exemplary phrases may be provided to the user to try at the outset, which can be skipped at any time by clicking on the “Let's Get Started” button. The exemplary launch process and phrases as shown in FIG. 14 might include:
1. MYKA® prompts for first phrase:
   a. “Welcome, Let's see what your sous chef is capable of.”
   b. “Try Saying . . . ”
2. When the user clicks on “try another phrase,” MYKA® will prompt:
   a. “Let's try another phrase.” This will play simultaneously when on screen, and the following sentence may be displayed—“Let's see what your sous chef is capable of.”
   b. “Try Saying . . . ”
3. Point (2) will be repeated for all other phrases.
4. If a phrase apart from a pre-defined phrase is given by the user, the application will try to identify the ingredients or MYKA® will state. “I am not sure I understand.
5. If the user does not speak for specific set time (which can be a default setting of, e.g., 5 seconds) then a notification will pop up and simultaneously MYKA® will prompt: “Hey Chef, let's get started.”

In FIG. 15, a cooking flow begins. When the user taps on “Start Cooking” for the first time, MYKA® will ask, “Hey Chef, do you want me to recite the ingredient list?” The user may respond:
“Yes”; whereby MYKA® will recite the list, stop when finished, and then prompt: “That's all from the list. Now, let's begin with Step 1.”
   or
“No”; whereby MYKA® will navigate the user to Step 1.

At any time MYKA® is not speaking, the user can ask MYKA® to go to the next step or previous steps, navigate to a specified step, or finish cooking. For example:
a. User commands: “Hey Myka . . . ” (a “ding” signal, for example, will sound to indicate that MYKA® is listening) “ . . . Go to Step 3/Go to the next step” (ding sound when MYKA® stops listening and acts or navigates accordingly). There will be no verbal response required from MYKA®.
b. User commands: “Hey Myka . . . ” (ding) “ . . . I am done cooking” (ding) after which MYKA® will take the user to the next scoped flow.

FIG. 16 shows a flow or order involving creation of a recipe. Here, when the user taps on the plus symbol (+) MYKA® will ask:
a. “Hey Chef, what would you like to call your yummy creation?” (followed by a ding so that the user will know when to start speaking);
b. User: “French toast” (a ding sound will follow shortly to inform the user that MYKA® is finished listening);
c. MYKA®: “Great, what's step one? (ding sound, to let user know when to speak)
d. User (after MYKA® dictates step one & it is detected by AI): “Hey Myka, (ding) let's save step 1/this step” (ding);
e. MYKA®: “What's step 2 ?” {Same for ‘n’ number of steps};
f. Adding note for specific step:
   i. User: “Hey Myka, (ding) let's add a note here”;
   ii. MYKA®: “Tell me what you want to add?” (ding);
   iii. User: “Add dash of lemon here to reduce the spice taste”;
   iv. MYKA®: “Note added”
g. Finish Cooking:
   i. User: “Hey Myka, (ding), I am done cooking”;
   ii. MYKA®: “Okay Chef” {MYKA® will then navigate the user to a preview screen)

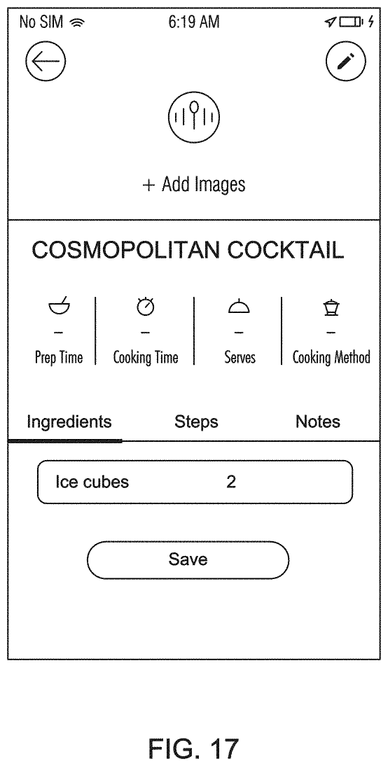

FIG. 17 shows a preview or “Store Recipe” screen accompanied by the following AI dialogue:

a. MYKA®: “Hey Chef, do you want to preview the recipe, or shall I save it?” (ding)
i. User: “Save the recipe” or “Yes”;
ii. MYKA®: “Recipe Saved.”
   OR
iii. User: “I want to review it” or “No”;
iv. MYKA®: “Okay, let's have a look.”

b. After User Review and/or changes or additional details, the user may command:
i. “Hey, Myka, Save the Recipe”;
ii. MYKA®: “Recipe saved.”

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

By way of example and not of limitation, exemplary embodiments as disclosed herein may include but are not limited to:

### Embodiment 1

A machine-learning system that can intelligently sort and articulate ingredients, quantities, steps, and conditions based on verbal descriptions from a user while cooking, the system interactively recording a resulting recipe.

### Embodiment 2

The machine-learning system as in embodiment 1, wherein the system can record the recipe and its ingredients, quantities, steps, and conditions for recall or for use in a new recipe.

### Embodiment 3

The machine-learning system as in embodiments 1 or 2, wherein the system learns from the recipe to make suggestions in new recipes.

### Embodiment 4

A machine-learning system as in any of the foregoing embodiments, wherein the system interactively engages with the user to learn what the user means by terms and observations.

### Embodiment 5

A machine-learning system as in any of the foregoing embodiments, wherein, after learning and recording ingredients, quantities, steps, and conditions in the recipe in a library, a new recipe is formulated based upon the library.

### Embodiment 6

A method of training a neural network for recipe discernment and compilation comprising: collecting a set of information from the group consisting of temperatures, times, conditions, ingredients, quantities, visual appearance, and order of use; transforming one or more of the set of information to recipe steps; creating a library from the set of information; and training the neural network to intelligently assist in a subsequent recipe.

### Embodiment 7

An artificial intelligent system comprising a neural network trained to identify ingredients from steps stated by a user, display the steps to the user when prompted, and save the steps and ingredients and conditions in a library.

### Embodiment 8

The artificial intelligent system as in Embodiment 7, wherein the library can be modified or new conditions, steps, and ingredients can be added to the library.

### Embodiment 9

A method of iteratively creating and recording a recipe using a machine learning system, comprising: processing, by a chat system, an initial version of an artificial intelligence assistant based on a prepopulated library and a user input; generating, by the chat system, a response by the artificial intelligence assistant; inviting user feedback to accept or modify the response from the artificial intelligence assistant; and recording or modifying the response, the library or both the response and the library by the chat system, wherein the artificial intelligence assistant learns from the user feedback and the initial version is modified to an improved version.

### Embodiment 10

The method as in Embodiment 9, wherein the prepopulated library includes a first set of commands, a first set of ingredients, and a first set of units of measure.

### Embodiment 11

The method as in Embodiments 9 or 10, wherein the user input includes a name, location, and user preferences.

### Embodiment 12

The method as in Embodiments 9, 10, or 11, wherein the user can communicate with the artificial intelligence assistant by verbal or typed commands.

### Embodiment 13

The method as in any of the Embodiments 9 through 12, wherein the chat system in the improved version based on the user feedback and an expanded library, is able to suggest ingredients, steps, temperatures, and cooking times to the user in subsequent recipes.

### Embodiment 14

A machine learning cooking assistant comprising a processor, a tangible, non-transitory memory configured to communicate with the processor, the tangible, non-transitory memory having commands stored thereon that, in response to execution by the processor, causes the processor to perform operations comprising: processing, by the processor, a user chat input; selecting, by the processor, a current version of a recipe library based on the processed user chat input; generating, by the processor, an AI chat response based on the processed user chat input and a current version of the support chat profile; generating, by the processor, an AI query; receiving, by the processor, user chat feedback; and modifying, by the processor, the current version of the recipe library to an expanded version of the recipe library.

### Embodiment 15

The machine learning cooking assistant as in Embodiment 14, wherein the processor mimics a helpful assistant based on a transformation of the current version of the recipe library to the expanded version of the recipe library.

### Embodiment 16

The machine learning cooking assistant as in Embodiments 14 or 15, wherein the processor, through iterative learning, makes suggestions via the AI chat.

That which is claimed is:

1. An artificial intelligence system for interactively participating in a recipe creation, the artificial intelligence system comprising:
a processor having a user interface; and
a memory that stores executable instructions that, when executed by the processor, facilitates creation of a recipe based on a first data set inputted by a user through the user interface, correlates the first data set to defined parameters in the memory, and generates an iterative machine-learned model in real-time, the machine-learned model including estimates suggested to the user through the user interface as a second data set.

2. The artificial intelligence system as in claim 1, wherein the user interface is a voice-activated or touch screen interface.

3. The artificial intelligence system as in claim 1, wherein the defined parameters in the memory include ingredients, quantities, steps, conditions, and combinations thereof.

4. The artificial intelligence system as in claim 1, wherein the first data set includes ingredients, quantities, steps, conditions, and combinations thereof.

5. The artificial intelligence system as in claim 1, wherein the second data set includes ingredients, quantities, steps, and conditions, and combinations thereof, different from the first data set.

6. The artificial intelligence system as in claim 1, wherein the system is configured to record ingredients, quantities, steps, conditions, and combinations thereof for recall and iterative learning.

7. The artificial intelligence system as in claim 1, wherein correlation of the first data set to the defined parameters causes the system to make suggestions to the user.

8. The artificial intelligence system as in claim 1, further comprising a neural network that causes the system to interactively engage with the user to learn what the user means by new terms inputted through the user interface.

9. A method of training a neural network for recipe discernment and compilation, the method comprising:
inputting a first set of information in a library in the processor;
collecting a second set of information from a user from the group consisting of temperatures, times, conditions, ingredients, quantities, visual appearance, order of use, and combinations thereof;
training a neural network in the processor by correlating the first and second sets of information;
creating a library from the recipe steps; and
causing the neural network to autonomously assist the user to create recipe steps or to create a subsequent recipe.

10. The method as in claim 9, wherein the library is created by identifying the ingredients and the conditions from steps stated by a user, displaying the steps to the user when prompted, and saving the steps, the ingredients, and the conditions in the library upon user command.

11. A method of iteratively creating and recording a recipe using a machine learning system, the method comprising:
processing, by a chat system, an initial version of an artificial intelligence assistant based on a prepopulated library and a user input;
generating, by the chat system, a response by the artificial intelligence assistant;
inviting user feedback to accept or modify the response from the artificial intelligence assistant; and
recording or modifying the response, the library, or both the response and the library by the chat system, wherein the artificial intelligence assistant learns from the user feedback and the initial version is modified to an improved version.

12. The method as in claim 11, wherein the prepopulated library includes a first set of commands, a first set of ingredients, and a first set of units of measure.

13. The method as claim 11, wherein the user input includes a name, location, and user preferences.

14. The method as claim 11, wherein the artificial intelligence assistant is controlled by verbal or typed commands.

15. The method as in claim 11, wherein the chat system in the improved version is configured to suggest ingredients, steps, temperatures, and cooking times to the user in subsequent recipes.

16. A machine learning cooking assistant comprising:
a processor;
a tangible, non-transitory memory configured to communicate with the processor, the tangible, non-transitory memory having commands stored thereon that, in response to execution by the processor, causes the processor to perform operations comprising: processing, by the processor, a user chat input; selecting, by the processor, a current version of a recipe library based on the processed user chat input; generating, by the processor, an AI chat response based on the processed user chat input and a current version of the support chat profile; generating, by the processor, an AI query; receiving, by the processor, user chat feedback; and modifying, by the processor, the current version of the recipe library to an expanded version of the recipe library.

17. The machine learning cooking assistant as in claim 16, wherein the processor artificially mimics a human assistant based on a transformation of the current version of the recipe library to the expanded version of the recipe library.

18. The machine learning cooking assistant as in claim 16, wherein the processor, through iterative learning, makes suggestions to the user via the AI chat response.
